(19) United States
(12) Patent Application Publication
(10) Pub. No.: US 2005/0283767 A1
(43) Pub. Date: Dec. 22, 2005

(54) Method and apparatus for preventing unwanted information to be displayed to a user of a computer

(76) Inventor: Fitim Blaku, Flushing, NY (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/081,463

(22) Filed: Mar. 16, 2005

Related U.S. Application Data
(63) Continuation-in-part of application No. 10/874,050, filed on Jun. 22, 2004.

(51) Int. Cl. G06F 9/45

(52) U.S. Cl. 717/140

(57) ABSTRACT

A method and an apparatus 60 which filters unwanted pop up type of information and which is effective to prevent pop up information from being displayed to a user of a computer 10.

### BACKGROUND

(1). Field of the Invention

The present invention generally relates to a method and an apparatus for preventing unwanted information to be displayed to a user of a computer and, more particularly, to a method and an apparatus for receiving information in the form of “pop-up” advertisements or “pop-up” window opening commands and for selectively filtering the received information in a manner which is effective to prevent some or substantially all of the received information to be prevented from being displayed to a user of the computer and, more particularly, from substantially preventing unwanted pop-up windows to be undesirably displayed to a user of a computer.

(2). Background of the Invention

Computers have traditionally been used in a wide variety of applications involving the local processing and manipulation of information (i.e., the term “local” means, in this context, that the data or information received by the computer is limited to that which is created and input by use of a keyboard or other device which is physically and/or locally connected to the computer). However, there has been a great proliferation in the networking of these computers by the use of local and worldwide networks, such as and without limitation, by the use of publicly available world wide networks, such as that which is commonly referred to as “The Internet”. While such networks do allow these computers to quickly share and manipulate data and information from a wide variety of remote sources, thereby increasing and enhancing the overall functionality and usefulness of these computers, there are some drawbacks.

By way of example and without limitation, this networking proliferation has motivated some to develop techniques and strategies for creating and sending unwanted information to the various users of these networks, primarily for advertising purposes, although the unwanted information may take other forms and be sent for other purposes. Particularly, such unwanted information has come to be known as “pop up” advertisements or ads, or simply “pop ups” or “pop-up windows”. As should be known to those of ordinary skill in the art, the name “pop up” was derived from the sudden and unexpected manner in which the information is displayed upon the screen of a computer which is communicatively coupled to a network, such as The Internet. This sudden, undesired, and unexpected display is typically manifested in a “pop-up” window which is typically opened and displayed to a user who is employing a computer utilizing a Windows type of operating system. It should be understood to the reader that the term “pop up”, as used in this description, refers to any type of unwanted information which is remotely sent to a networked computer and this definition includes, but is not limited to, a pop up window.

These pop ups are annoying, both in their frequency of receipt and in their content (i.e., oftentimes such pop ups include offensive or pornographic material), and potentially dangerous and destructive to the computer which receives them since they may contain one or more computer viruses and/or may actually allow the sender to control or gain access to various portions of the computer.

There is therefore a need and it is a principle object of the various inventions to filter such unwanted information and substantially prevent such unwanted information from being displayed upon the receiving computer while substantially preventing the received and unwanted information from damaging the computer or performing undesired actions with respect to the receiving computer.

### SUMMARY OF THE INVENTION

It is a first non-limiting object of the present invention to provide a method and an apparatus to overcome the various afore-delineated drawbacks associated with the use of various computer networks.

It is a second non-limiting object of the present invention to provide a method and an apparatus to overcome the various afore-delineated drawbacks associated with the user of various computer networks and which, by way of example and without limitation, substantially filters unwanted information and substantially prevents such unwanted information from being displayed to a user of a computer which is communicatively coupled to these networks.

It is a third non-limiting object of the present invention to provide a method and an apparatus which allows only a certain selected portions of unwanted information to be selectively displayed to a user of a computer which is communicatively and operatively coupled to a network, such as and without limitation, The Internet.

It is a fourth non-limiting object of the present invention to provide a method and an apparatus which substantially prevents unwanted information, such as pop up information, to adversely effect a computer, such as and without limitation, a computer which is communicatively and operatively coupled to a network.

According to a first non-limiting aspect of the present invention, an apparatus is provided and includes software which is selectively and operatively placed within a computer and which substantially prevents pop up advertisements from being displayed to a user of the computer.

According to a second non-limiting aspect of the present invention, a method is provided and includes the steps of receiving pop up advertisement information; determining the source of the received information; and preventing the received pop up advertisement information from being displayed to a user of a computer based upon the identity of the source.

These and other features, aspects, and advantages of the present invention will become apparent to those of ordinary skill in the art by reference to the following detailed description of the preferred embodiment of the invention, including but not limited to by reference to the subjoined claims, and by reference to the following drawings.

### BRIEF DESCRIPTION OF THE DRAWINGS

FIG. 1 is a block diagram of a computer which utilizes and which includes the preferred embodiment of the invention and which is further communicatively and operatively coupled to a network, such as the Internet.

### DETAILED DESCRIPTION OF THE PREFERRED EMBODIMENT OF THE INVENTION

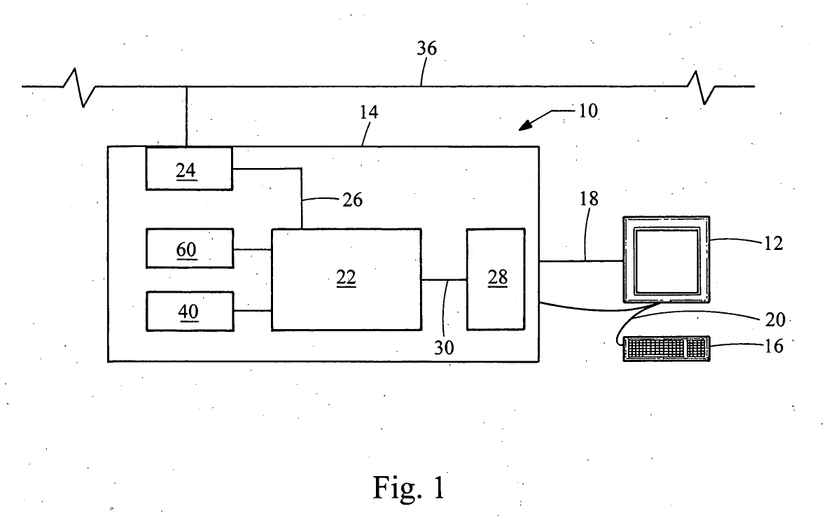

Referring now to FIG. 1, there is shown a computer 10 which is made in accordance with the teachings of the preferred embodiment of the invention (e.g., the computer 10 includes the apparatus of the preferred embodiment of the invention and operates in accordance with the methodology of the preferred embodiment of the invention).

Particularly, the computer 10 includes a display portion 12, a processor portion 14 which is operatively and communicatively coupled to the display portion 12 by a bus 18, and a data input or keyboard portion 16 which is operatively and communicatively coupled to the processor portion 14 by the use of bus 20. It should be realized that computer 10 is meant to signify a general type of computer and that nothing in this description is meant to limit the various inventions to a particular type of computer.

It should be appreciated that the processor portion 14 typically includes a central processor 22, acting under stored program control, (e.g., a Pentium 4 processor), a communications portion 24 which is coupled to the processor 22 by a bus 26, and a memory portion 28 which is coupled to the processor 22 by the use of bus 30. It should be further appreciated that the program may be selectively stored within and read from the memory portion 28 and that communications portion 24 is adapted to be selectively coupled to a network, such as network 36, which allows the computer 10 to remotely communicate with other computers and to receive a variety of remotely generated information. Particularly, the information is received by the communications portion 24 and is then selectively displayed upon the display portion 12 under the command and control of the processor 22. Data or information may be selectively created by the use of input device 16 and sent to communications portion 24, under the direction and control of the processor 22, where it is remotely sent to other computers and users by the use of network 36. In the foregoing manner, the computer 10 may communicate other computers by the use of the network 36. Typically, the network communications is done by the use of a browser software application 40 whose code is resident within the memory 28.

The apparatus of the present invention is diagrammatically illustrated by reference number 60 and may physically be manifested in a chip or in some medium containing source code (e.g., a disk, a combination of firmware and software, or a “plug in memory stick”) which may be selectively “read by” or communicated to or operatively placed within the computer 10 and stored within the memory portion 28. Particularly, the software code which is included within this medium is read by the processor portion 22 and is used in combination with the browser software application portion 40. The methodology associated with the preferred embodiment of the invention, as well as methodological functionality which is associated with other non-limiting embodiments of the invention are generally delineated below.

According to the methodology of the preferred embodiment of the invention, every five seconds (or some other pre-selected or pre-defined period of time), the portion 60 will discern the identity of every homepage of every browser which is operatively installed within the computer 10 (e.g., within the memory portion 28). This information, in one non-limiting embodiment of the invention, may be stored within the memory portion 28 and later selectively retrieved by the portion 60. The portion 60 will then (or concurrently with identifying the various browsers) determine whether a browser window is open. If a browser window is open (e.g., the browser or information associated with the browser is displayed on display 12), the portion 60 will determine if the “target URL” portion of that browser is the same as that browser's previously identified homepage. If the target URL portion is the same as that browser's previously identified homepage, the portion 60 allows remote communication to occur with the computer 10, and more particularly, by use of the open browser, because communication is occurring with the homepage to which that browser has been identified and the portion 60 assumes that the user of computer 10 would like to remotely communicate with that homepage. In this manner, portion 60 continually determines the identity of the browsers which are installed within computer 60 and associates each of these identified browsers with a certain homepage or identifies the homepage of each of these browsers. Then the portion 60 continually determines which browsers have been open (if any) and for each of these open browsers, the portion 60 continually monitors the respective homepages of these browsers and each of the respective target URLs which are associated with these browsers and respectively compares the target URLs with the homepages to determine whether to respectively allow remote communication to occur by use of these respective browsers. Thus, the methodology of the preferred embodiment of the invention is dynamic in the sense that it continually determines whether remote communication should proceed by use of a comparison of two continually acquired metrics; the respective browser based target URLs and the respective homepages (e.g., for each browser, the homepage of each browser is compared with the target URL of the browser).

As should be appreciated, if the target URL portion is not the same as the previously identified homepage for that browser, then the portion 60 assumes that any communication from the remote computer, identified by this target URL, is some sort of unwanted spyware or pop-up and should be prevented from being displayed upon display 12. In one non-limiting and alternate embodiment of the invention, if the window of information (i.e., “the window”) which is to be displayed was actually user-requested from a program, such as from Outlook Express, the “Scroll Lock” hotkey may be used to temporarily disable or enable the afore-described blocking operation (i.e., upon receipt of the “Scroll Lock” command which may be selectively generated by use of the keyboard or data input portion 12, the portion 60 becomes disabled until a second receipt of the command is received or becomes disabled for a certain predetermined period of time or becomes disabled only to allow the window of information to be displayed).

If a browser window is already opened when the portion 60 is “loaded” into the computer 10, then the portion 60 will determine whether the target URL, associated with the open window, is the same as the homepage which is associated with that browser. If the target URL and the homepage are determined to be similar, then the remote communication between computer 10 and the entity which is identified by the target URL is allowed. If they are not the same, then the portion 60 will determine whether the “title” of that opened browser window is the same as any other title of that same type of browser window and if it is the same, portion 60 will allow the remote communication with the entity which is represented by the target URL. If not, the unwanted information which may have been received from the entity which is represented by the target URL is prevented from being displayed to the user of the computer 10 by use of display 12.

When a browser is opened which is deemed to be “legitimate” in accordance with the above-delineated procedures (i.e., the term “legitimate”, in this context, means that remote communication is allowed), the source code and any files which may be included within that browser will be scanned by the portion 60 before any information associated with that browser (e.g., such as that which has been remotely received from another entity) is actually displayed to a user of the computer 10. Particularly, in this alternative embodiment of the invention, any data which is included in the file labeled “this-text” will be parsed for portions which are included in “http://*” and “www.*” types of statements and placed within a data table, resident within portion 60, and associated with that browser. If however, these statements are included within nested braces (e.g., of the type <!---<a href=“x”>--->), they will be discarded by the portion 60 and remote communication will be terminated. This ensures that the portion 60 (e.g., the “window blocker”) is not “fooled”.

To illustrate this portion of the methodology further, assume that the following text was received and parsed by portion 60:
Text (1)-<a href=“this-text”>
Text (2)-<a onClick=“this-text”>
Text (3)-<META HTTP-EQUV=Refresh CONTENT=“10; RL=this-text”>
   Further, if for purposes of this illustration, we assume that the homepage of the opened Internet browser is google.com, then the homepage would be scanned in the manner indicated above and the following URLs would be detected and placed into a database of valid windows for this browser:
www.google.com/imghp?hi=en&tab=wi&ie=UTF-8&oe=UTF-8
www.google.com/grphp?hi=en&tab=wi&ie=UTF-8&oe=UTF-8
www.google.com/nwshp?hi=en&tab=wi&ie=UTF-8&oe=UTF-8
www.google.com/froogle?hi=en&tab=wi&ie=UTF-8&oe=UTF-8
www.google.com/options/index.html
www.google.com/ads/solutions.html
www.google.com/services/

If any of the pop-up information were to try to be “opened” within a window of information which is resident within this browser, their target URL would be matched against one of the URLs listed above. If a match occurs, then the window is allowed to open and the information included within the open window is, of course, displayed to a user of the computer 10 by use of the display 12. If a match does not occur, the window of information is closed and the pop up information is not allowed to be displayed to a user of the computer system 10.

Further, in an alternate embodiment of the invention, if any of these functions include any functions which are conventionally used to open windows, the window will not open and these functions are as follows:
OnLoad=“ ”
onUnload=“ ”
OnMouseover=“ ”
setTimeout( )
   That is, portion 60 will monitor the generation of these functions from the data input portion (i.e., keyboard portion 14) and will either prevent these functions from being communicated to the processor portion, or will communicate necessary commands to the processor portion which are effective to have the processor portion suppress its conventional or typical response to these proffered commands.

In another embodiment of the invention, as earlier delineated, the retrieved URLs must not lie within nested braces or else they will be disregarded by the portion 60 (e.g., <!--- <a href=“x”>--->). Further, when the parsing operation is activated, the “+” symbol will be ignored within the parsed field in order to avoid a common technique used by advertisers and others to cause pop up windows to occur. For example, the normal command to open pop up window is as follows:
Window.open(‘http://www.aol.com’,‘AOL’)
   A common “work around” to “fool” existing defenses within a computer, such as computer 10 is as follows:
Window.open(‘http://www.’+‘aol.com’, ‘AOL’).

Further, in yet another non-limiting embodiment of the invention, the portion 60 will suppress the “script error” function in case a browser application attempts to communicate with a pop-up window that has been previously been closed and this prevents the user from seeing an annoying error message because a pop up window was closed.

Further, in yet another non-limiting embodiment of the invention, all functions which are used to open windows will not work unless they lie within a function of the type, onClick=here. If more than one function used to open a window lies inside of the, <onClick=“ ”> function, then the function will only be executed once to prevent multiple windows.open functions from occurring.

For example, the following function would be allowed:

| | |
|---|---|
| <a | href=http://www.hotmail.com |

onClick=“window.open(‘goodbye.html’, ‘goodbye’);”

Additionally, the following would also be allowed:

<script>
Function openIT( )
{

window.open(‘goodbye.html’, ‘goodbye’);

}
</script>

which may be placed in the <head> section of the file and the following which may be placed in the <body> section of the file:
<a href=http://www.hotmail.com onClick=“openIt( );”>

The following would not be allowed:

| | |
|---|---|
| <a | href=http://www.hotmail.com |

onClick=“window.open(‘goodbye.html’, ‘goodbye’);
window.open(‘seeya.html’, ‘seeya’);”>

In the foregoing case, only the first window would actually open (i.e., goodbye.html), but since the limit is only one window.open per onClick, the second attempt to open a window (seeya.html) would not be allowed.

In yet another non-limiting embodiment of the invention, the portion 60 disables the “click( ) function”, and the portion 60 disables the “window.showHelp( );” function and prompts the user if it is closed. In yet another non-limiting embodiment of the invention, if a URL is received within the computer 10, the portion 60 checks to see if it has a portion corresponding to https:// and ftp://. That is, a URL of “allowed popup” is www.orders.com and, in this non-limiting embodiment, http://www.orders.com is allowed as is https://www.orders.com and as is ftp://www.orders.com.

In yet another non-limiting embodiment of the invention, the database operation, discussed above, is modified. That is, a link may be constructed as follows (i.e., the “href=” section includes javascript code): <a href=“javascript:window.open(‘www.google.com’,‘google’); ” onClick=“window.open(‘www.cnn.com’,‘cnn’);”> Link</a>

In this case, with the use of current techniques and strategies, each “window.open” command causes respectively unique windows to be opened. Thus, an entity/user may use the “on click” section of a link to launch a pop up, and the “href” section to launch the actual website that the user really wants to view. This is prevented in this nonlimiting embodiment.

That is, although prior embodiment, required that anything in the <a href=“this-text”> section will be added to the database, one exception is added in this alternative embodiment. First, before “this-text” is added to the database, “this-text” will be parsed and will be checked, by portion, to see if the first characters are of the “javascript:” type. If they are, then the portion 60 checks to determine whether there exists a “window.open” type function called within “this-text”, and if there is, portion 60 checks whether if any “window.open” functions are called inside the onClick=“ ” function. If there is one located inside this link, the URL in the “onClick” type function will be ignored and not added to the allowed-URL database. However, if there is no “javascript”: inside the href=“ ” section, portion 60 continues using the above described operation. To illustrate this technique, several examples are delineated below.

A link on a website is as follows:

### EXAMPLE #1

| | |
|---|---|
| <a | href=“javascript:window.open(‘www.cnn.com/money’, |

‘cnnfn’);”>LINK</a>

In this case, Portion 66 will “grab” the text javascript:window.open(‘www.cnn.com/money’,‘cnnfn’); and notice the preceding javascript:, and if there is a “window.open” command inside this javascript statement, Portion 60 will add that URL to its allow-list and will check if there is a onClick=“ ” section in this link. In this case, there is no onClick=“ ” so all else will proceed as described above.

### EXAMPLE #2

<a
href=“javascript:window.open(‘www.cnn.com/money’, ‘cnnfn’);
window.open(‘www.jokes.com,‘jokes’):”>LINK</a>

In this case, Portion 66 will do the same as it did above, but will not execute the second “window.open” statement. That is the second “window.open( )function” will not be added to the allowed URL list for that browser, leaving it useless).

### EXAMPLE #3

<a

href=“javascript:window.open(‘www.cnn.com/money’, ‘cnnfn’);”
onClick=window.open(‘www.aol.com’, ‘aol’);”>LINK</a>

Here, Portion 60 will “grab” the text javascript:window.open(‘www.cnn.com/money’,cnnfn’); and notice the preceding javascript:, and if there is a “window.open” type command inside this javascript statement, Portion 60 will add that URL to its allow-list and will check if there is a onClick=“ ” section to this link. In this certain case, there is a onClick=“ ”, so Portion 60 will recognize that “window.open” was already used in the href=“ ” section of the link and will completely disregard the window.open command inside the onClick. (i.e. will not add to allowed-list of URLs).

It should be understood that the invention is not to be limited to the exact construction and method which have been illustrated and discussed above, but that various changes and modifications may be made without departing from the spirit and the scope of the invention as delineated in the following claims. Further, in another non-limiting embodiment of the invention, portion 60 will ignore all types of HTML/Javascript comments when parsing received text, including comments which are written in Java Script type language (i.e. “//” and “/*”). In yet another non-limiting embodiment, the “Scroll Lock” key may be replaced with any other key the user desires to enable or disable the operation of portion 60 by the use of the functionality provided by the “Options” section of the provided operating software, such as Windows based software.

Further, in another non-limiting embodiment of the invention, processor portion 14 closes all open browser windows upon receipt of a command from the keyboard 16 or upon receipt of a voice command which is recognized by voice recognition software, such as Dragon type software, which may be operatively resident upon/within the processor portion 14. In yet, another non-limiting embodiment, the processor portion automatically closes all these windows when the occurrence of a predefined event (e.g., by selecting and concomitantly pressing the “control” and “F12” keys) and, in yet another non-limiting embodiment, by selecting and concomitantly pressing these two keys three separate times within five seconds, the processor portion closes all open software applications. Such applications could include software on a Linux® type system, on an Apple® type system, on a Windows® type system, or on a personal data type device.

1) An apparatus comprising software which is selectively and operatively placed within a computer and which substantially prevents pop up type of information from being displayed to a user of the computer; and which further has a portion which selectively closes all open browsers.

2) The apparatus of claim 1 wherein said software is operatively resident upon a computer readable disk.

3) The apparatus of claim 1 wherein said software substantially prevents said pop up type of information to be displayed by use of at least one target URL and at least one homepage.

4) The apparatus of claim 3 wherein said pop up type of information is only displayed if said at least one target URL and the identity of said at least one homepage are substantially identical.

5) The apparatus of claim 4 wherein said apparatus may be selectively disabled by a user.

6) A method comprising the steps of receiving pop up information; determining the source of the received information; and preventing the received pop up information from being displayed to a user of a computer based upon the identity of the source.

7) The method of claim 6 wherein said step of determining the source of said received information comprises the step of determining the identity of a target URL.

8) The method of claim 6 wherein said step of preventing said pop up information from being displayed to a user of said computer comprises the further step of determining the identity of a homepage; comparing the identity of said homepage to said target URL; and allowing said information to be displayed only if said identity of said homepage is substantially similar to said target URL.

9) The method of claim 8, wherein said computer includes a click function and wherein said method comprises the step of selectively disabling said click function.

10) The method of claim 8 wherein said computer includes a showhelp function and wherein said method includes the step of disabling said showhelp function.

11) The method of claim 8 wherein said computer includes a scroll lock function and wherein said method includes the step of interrupting said method upon activation of said scroll lock function.

12) The method of claim 11 wherein said interruption of said method is terminated within a certain predetermined period of time.

13) The method of claim 11 wherein said interruption of said method continues until another activation of said scroll lock function occurs.

14) The method of claim 11 wherein said interruption of said method is terminated after a browser is closed.

15) A method for use with a computer of the type having at least one browser and at least one homepage which is selected by use of said at least one browser, said method comprising the steps of automatically and periodically identifying said at least one homepage of said at least on browser; receiving information from an entity, said entity having a certain target URL; comparing the identity of said certain target URL with said identity of said at least one homepage; and displaying said received information if said identity of said certain target URL is substantially similar to said identity of said at least one homepage.

16) The method of claim 15 further comprising the steps of temporarily disabling said method upon receipt of a certain functional command.

17) The method of claim 16 wherein said certain functional command comprises a scroll lock functional command.

18) The method of claim 17 wherein said temporary disablement occurs for a certain predetermined period of time.

19) The method of claim 18 wherein said certain predetermined period of time comprises about one to about five minutes.

20) The method of claim 18 wherein said certain predetermined period of time is selectable.

21) The method of claim 20 wherein said certain predetermined period of time is bounded by the receipt of a second scroll lock command function.

22) The method of claim 18 wherein said computer includes a click function and wherein said method includes the step of disabling said click function.

23) The method of claim 22 wherein said computer includes a show help function and wherein said method includes the step of disabling said show help function.

24) The method of claim 22 wherein said computer includes determining whether the target URL information occurs within a nested brace; and preventing said display of said pop up information if said target URL occurs within said nested brace.

25) The method of claim 24 wherein said computer includes a script function and wherein said method includes the step of disabling said script function.
